(19) United States
(12) Patent Application Publication
(10) Pub. No.: US 2026/0005611 A1
(43) Pub. Date: Jan. 1, 2026

(54) ELECTRIC POWER CONVERSION APPARATUS AND ELECTRIC POWER CONVERSION SYSTEM

(71) Applicant: TDK Corporation, Tokyo (JP)

(72) Inventor: Masaharu MORITSUGU, Tokyo (JP)

(73) Assignee: TDK Corporation, Tokyo (JP)

(21) Appl. No.: 19/236,187

(22) Filed: Jun. 12, 2025

(30) Foreign Application Priority Data
Jun. 27, 2024 (JP) 2024-104028

(51) Int. Cl. H02M 3/335

(52) U.S. Cl. CPC H02M 3/3353

(57) ABSTRACT

An electric power conversion apparatus includes: an electric power input terminal; an electric power output terminal; an electric power conversion circuit; a sensor circuit generating a detection voltage corresponding to a voltage at the electric power output terminal; a control circuit operable based on a first power supply voltage, including an input terminal to receive the detection voltage, and controlling operation of the electric power conversion circuit; and a power supply circuit generating the first power supply voltage and a second power supply voltage. The sensor circuit includes: resistors provided in a path coupling the electric power output terminal to a reference node, the resistors being coupled in series via first and second intermediate nodes, the second intermediate node being coupled to the input terminal; and a first diode including an anode coupled to the first intermediate node, and a cathode to be supplied with the second power supply voltage.

### CROSS-REFERENCE TO RELATED APPLICATIONS

The present application claims priority from Japanese Patent Application No. 2024-104028 filed on Jun. 27, 2024, the entire contents of which are hereby incorporated by reference.

### BACKGROUND

The disclosure relates to an electric power conversion apparatus and an electric power conversion system that each convert electric power.

In electronic circuitry, a situation such as an overcurrent or an overvoltage can cause damage to a circuit. For example, Japanese Unexamined Patent Application Publication No. Hei 10-116552 discloses a switching device that protects a circuit upon occurrence of the overcurrent.

### SUMMARY

An electric power conversion apparatus according to one embodiment of the disclosure includes an electric power input terminal, an electric power output terminal, an electric power conversion circuit, a sensor circuit, a control circuit, and a power supply circuit. The electric power conversion circuit is configured to perform an electric power conversion operation, based on electric power received at the electric power input terminal, and is configured to output electric power generated through the electric power conversion operation from the electric power output terminal. The sensor circuit is configured to generate, based on a voltage at the electric power output terminal, a detection voltage corresponding to the voltage at the electric power output terminal. The control circuit is configured to operate based on a first power supply voltage. The control circuit includes an input terminal configured to receive the detection voltage, and is configured to control operation of the electric power conversion circuit, based on the detection voltage. The power supply circuit is configured to generate, based on the electric power received at the electric power input terminal, the first power supply voltage and a second power supply voltage, the second power supply voltage being higher than the first power supply voltage. The sensor circuit includes resistors and a first diode. The resistors are provided in a path coupling the electric power output terminal and a reference node to each other, and are coupled in series to each other via a first intermediate node and a second intermediate node. The second intermediate node is positioned closer to the reference node than the first intermediate node, and is coupled to the input terminal of the control circuit. The first diode includes an anode coupled to the first intermediate node, and a cathode configured to be supplied with the second power supply voltage.

An electric power conversion system according to one embodiment of the disclosure includes a first battery, a capacitor, a first switch, a second switch, an electric power conversion apparatus, and a second battery. The first battery includes a first terminal and a second terminal. The capacitor includes a first terminal and a second terminal. The first switch is provided in a path coupling the first terminal of the first battery and the first terminal of the capacitor to each other. The second switch is provided in a path coupling the second terminal of the first battery and the second terminal of the capacitor to each other. The electric power conversion apparatus includes an electric power input terminal, an electric power output terminal, an electric power conversion circuit, a sensor circuit, a control circuit, and a power supply circuit. The electric power input terminal is coupled to the capacitor. The electric power output terminal is coupled to the second battery. The electric power conversion circuit is configured to perform an electric power conversion operation, based on electric power received at the electric power input terminal, and is configured to output electric power generated through the electric power conversion operation from the electric power output terminal. The sensor circuit is configured to generate, based on a voltage at the electric power output terminal, a detection voltage corresponding to the voltage at the electric power output terminal. The control circuit is configured to operate based on a first power supply voltage. The control circuit includes an input terminal configured to receive the detection voltage, and is configured to control operation of the electric power conversion circuit, based on the detection voltage. The power supply circuit is configured to generate, based on the electric power received at the electric power input terminal, the first power supply voltage and a second power supply voltage, the second power supply voltage being higher than the first power supply voltage. The sensor circuit includes resistors and a first diode. The resistors are provided in a path coupling the electric power output terminal and a reference node to each other, and are coupled in series to each other via a first intermediate node and a second intermediate node. The second intermediate node is positioned closer to the reference node than the first intermediate node, and is coupled to the input terminal of the control circuit. The first diode includes an anode coupled to the first intermediate node, and a cathode configured to be supplied with the second power supply voltage.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a circuit diagram illustrating a configuration example of an electric power conversion system according to one example embodiment of the disclosure.

FIG. 2 is a circuit diagram illustrating a configuration example of a sensor circuit illustrated in FIG. 1.

FIG. 3 is an explanatory diagram illustrating an example of circuit constants of the sensor circuit illustrated in FIG. 2.

FIG. 4 is an explanatory diagram illustrating an operation example of the sensor circuit illustrated in FIG. 2.

FIG. 5 is an explanatory diagram illustrating another operation example of the sensor circuit illustrated in FIG. 2.

FIG. 6 is a circuit diagram illustrating a configuration example of a sensor circuit according to a reference example.

FIG. 7 is a circuit diagram illustrating a configuration example of a sensor circuit according to a modification example.

### DETAILED DESCRIPTION

It is desired to protect a circuit in electronic circuitry, and also in an electric power conversion apparatus.

It is desirable to provide an electric power conversion apparatus and an electric power conversion system that each make it possible to protect a circuit.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings. Note that the description is given in the following order.

### Example Embodiment

### Configuration Example

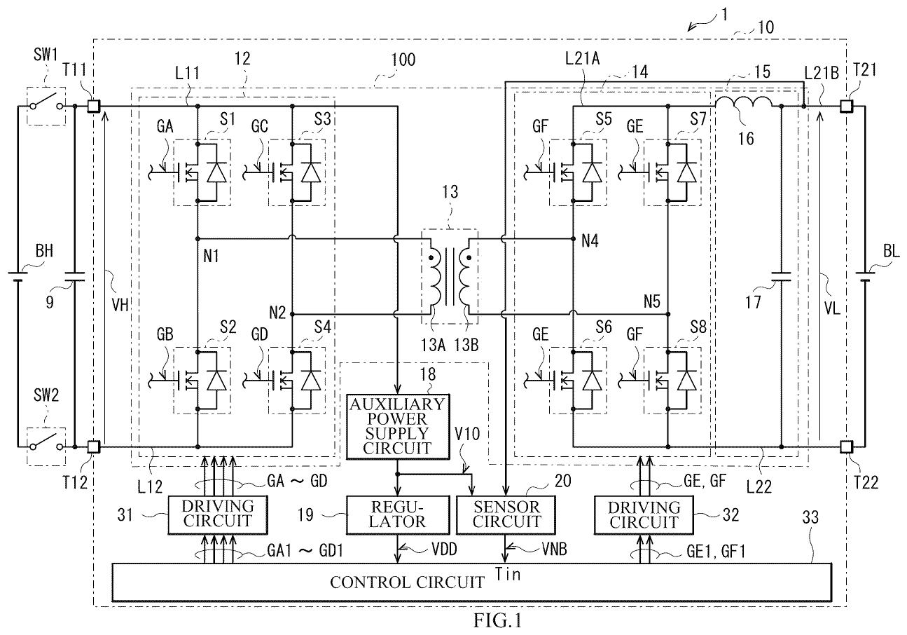

FIG. 1 illustrates a configuration example of an electric power conversion system 1 including an electric power conversion apparatus according to an example embodiment of the disclosure. The electric power conversion system 1 includes a high voltage battery BH, switches SW1 and SW2, a capacitor 9, an electric power conversion apparatus 10, and a low voltage battery BL. The electric power conversion system 1 may be configured to convert electric power supplied from the high voltage battery BH and to supply the converted electric power to the low voltage battery BL.

The high voltage battery BH may be configured to store electric power. A voltage at the high voltage battery BH may be 400 V in the example embodiment. The high voltage battery BH may supply the electric power to the electric power conversion apparatus 10 via the switches SW1 and SW2.

The switches SW1 and SW2 may be configured to supply the electric power stored in the high voltage battery BH to the electric power conversion apparatus 10 when turned on. The switches SW1 and SW2 may each include a relay, for example. When turned on, the switch SW1 may couple a positive terminal of the high voltage battery BH and a terminal T11 of the electric power conversion apparatus 10 to each other. When turned on, the switch SW2 may couple a negative terminal of the high voltage battery BH and a terminal T12 of the electric power conversion apparatus 10 to each other. The switches SW1 and SW2 may be turned on and off based on instructions from an unillustrated system control processor.

The capacitor 9 may have a first end coupled to the terminal T11 of the electric power conversion apparatus 10 and to the switch SW1, and a second end coupled to the terminal T12 of the electric power conversion apparatus 10 and to the switch SW2.

The electric power conversion apparatus 10 may be configured to step down a voltage supplied from the high voltage battery BH to thereby convert the electric power, and to supply the converted electric power to the low voltage battery BL. The electric power conversion apparatus 10 may include the terminals T11 and T12, a switching circuit 12, a transformer 13, a rectifying circuit 14, a smoothing circuit 15, terminals T21 and T22, an auxiliary power supply circuit 18, a regulator 19, a sensor circuit 20, driving circuits 31 and 32, and a control circuit 33. Primary-side circuitry of the electric power conversion system 1 may include the high voltage battery BH, the switches SW1 and SW2, the capacitor 9, the switching circuit 12, and the driving circuit 31. Secondary-side circuitry of the electric power conversion system 1 may include the rectifying circuit 14, the smoothing circuit 15, the driving circuit 32, and the low voltage battery BL. The switching circuit 12, the transformer 13, the rectifying circuit 14, and the smoothing circuit 15 may constitute an electric power conversion circuit 100.

The terminals T11 and T12 may be configured to receive a voltage from the high voltage battery BH when the switches SW1 and SW2 are turned on. In the electric power conversion apparatus 10, the terminal T11 may be coupled to a voltage line L11, and the terminal T12 may be coupled to a reference voltage line L12. A voltage at the voltage line L11 with respect to a voltage at the reference voltage line L12 may be a voltage VH.

The switching circuit 12 may be configured to convert a direct-current voltage supplied from the high voltage battery BH into an alternating-current voltage. The switching circuit 12 may be a full-bridge circuit, and may include transistors S1 to S4. The transistors S1 to S4 may be switching devices that perform switching operations, respectively based on gate signals GA to GD. The transistors S1 to S4 may each include an N-type field-effect transistor (FET), for example. The transistors S1 to S4 may each include a body diode. For example, the body diode of the transistor S1 may include an anode coupled to a source of a body of the transistor S1, and a cathode coupled to a drain of the body of the transistor S1. This similarly applies to the transistors S2 to S4. Note that such a configuration is non-limiting. In some embodiments, an external diode device may be provided between the drain and the source of each of the transistors S1 to S4. Although the N-type field-effect transistor may be used in this example embodiment, this is non-limiting, and any kind of switching device may be used.

The transistor S1 may be provided in a path coupling the voltage line L11 and a node N1 to each other, and may be configured to couple the node N1 to the voltage line L11 when turned on. The drain of the transistor S1 may be coupled to the voltage line L11, a gate of the transistor S1 may receive the gate signal GA, and the source of the transistor S1 may be coupled to the node N1. The transistor S2 may be provided in a path coupling the node N1 and the reference voltage line L12 to each other, and may be configured to couple the node N1 to the reference voltage line L12 when turned on. The drain of the transistor S2 may be coupled to the node N1, a gate of the transistor S2 may receive the gate signal GB, and the source of the transistor S2 may be coupled to the reference voltage line L12.

The transistor S3 may be provided in a path coupling the voltage line L11 and a node N2 to each other, and may be configured to couple the node N2 to the voltage line L11 when turned on. The drain of the transistor S3 may be coupled to the voltage line L11, a gate of the transistor S3 may receive the gate signal GC, and the source of the transistor S3 may be coupled to the node N2. The transistor S4 may be provided in a path coupling the node N2 and the reference voltage line L12 to each other, and may be configured to couple the node N2 to the reference voltage line L12 when turned on. The drain of the transistor S4 may be coupled to the node N2, a gate of the transistor S4 may receive the gate signal GD, and the source of the transistor S4 may be coupled to the reference voltage line L12.

The transformer 13 may be configured to provide direct-current isolation and alternating-current coupling between the primary-side circuitry and the secondary-side circuitry, and configured to convert an alternating-current voltage supplied from the primary-side circuitry with a transformation ratio of the transformer 13 and supply the converted alternating-current voltage to the secondary-side circuitry. The transformer 13 may include windings 13A and 13B. The winding 13A may be a primary winding. The winding 13A may have a first end coupled to the node N1 in the switching circuit 12, and a second end coupled to the node N2 in the switching circuit 12. The winding 13B may be a secondary winding. The winding 13B may have a first end coupled to a node N4 in the rectifying circuit 14, and a second end coupled to a node N5 in the rectifying circuit 14. The nodes N4 and N5 will be described later.

The rectifying circuit 14 may be configured to rectify the alternating-current voltage supplied from the winding 13B of the transformer 13. The rectifying circuit 14 may be a full-bridge circuit, and may include transistors S5 to S8. The transistors S5 to S8 may each be configured to perform a switching operation, based on a gate signal GE or GF. The transistors S5 to S8 may each include, for example, an N-type field-effect transistor, as with each of the transistors S1 to S4 of the switching circuit 12. The transistors S5 to S8 may each include a body diode, as with each of the transistors S1 to S4.

The transistor S5 may be provided in a path coupling a voltage line L21A and the node N4 to each other, and may be configured to couple the node N4 to the voltage line L21A when turned on. The transistor S5 may include a drain coupled to the voltage line L21A, a gate to receive the gate signal GF, and a source coupled to the node N4. The transistor S6 may be provided in a path coupling the node N4 and a reference voltage line L22 to each other, and may be configured to couple the node N4 to the reference voltage line L22 when turned on. The transistor S6 may include a drain coupled to the node N4, a gate to receive the gate signal GE, and a source coupled to the reference voltage line L22.

The transistor S7 may be provided in a path coupling the voltage line L21A and the node N5 to each other, and may be configured to couple the node N5 to the voltage line L21A when turned on. The transistor S7 may include a drain coupled to the voltage line L21A, a gate to receive the gate signal GE, and a source coupled to the node N5. The transistor S8 may be provided in a path coupling the node N5 and the reference voltage line L22 to each other, and may be configured to couple the node N5 to the reference voltage line L22 when turned on. The transistor S8 may include a drain coupled to the node N5, a gate to receive the gate signal GF, and a source coupled to the reference voltage line L22.

The smoothing circuit 15 may be configured to smooth the voltage rectified by the rectifying circuit 14. The smoothing circuit 15 may include a choke inductor 16 and a capacitor 17. The choke inductor 16 may have a first end coupled to the voltage line L21A, and a second end coupled to a voltage line L21B. The capacitor 17 may have a first end coupled to the voltage line L21B, and a second end coupled to the reference voltage line L22. Although the choke inductor 16 may be provided on the voltage lines L21A and L21B in the example embodiment, this is non-limiting. In some embodiments, the choke inductor 16 may be provided on the reference voltage line L22, for example.

The terminals T21 and T22 may be configured to supply the voltage generated by the electric power conversion apparatus 10 to the low voltage battery BL. In the electric power conversion apparatus 10, the terminal T21 may be coupled to the voltage line L21B, and the terminal T22 may be coupled to the reference voltage line L22. Further, the terminal T21 may be coupled to a positive terminal of the low voltage battery BL, and the terminal T22 may be coupled to a negative terminal of the low voltage battery BL. A voltage at the voltage line L21B with respect to a voltage at the reference voltage line L22 may be a voltage VL.

The auxiliary power supply circuit 18 may be configured to generate a power supply voltage V10, based on the voltage VH at the terminals T11 and T12. In the example embodiment, the auxiliary power supply circuit 18 may include a flyback converter. The power supply voltage V10 may be 10 V in the example embodiment.

The regulator 19 may be configured to generate a power supply voltage VDD, based on the power supply voltage V10. The power supply voltage VDD may be 3.3 V in the example embodiment.

The sensor circuit 20 may be configured to generate a voltage VNB corresponding to the voltage VL at the terminals T21 and T22 and to supply the voltage VNB to the control circuit 33.

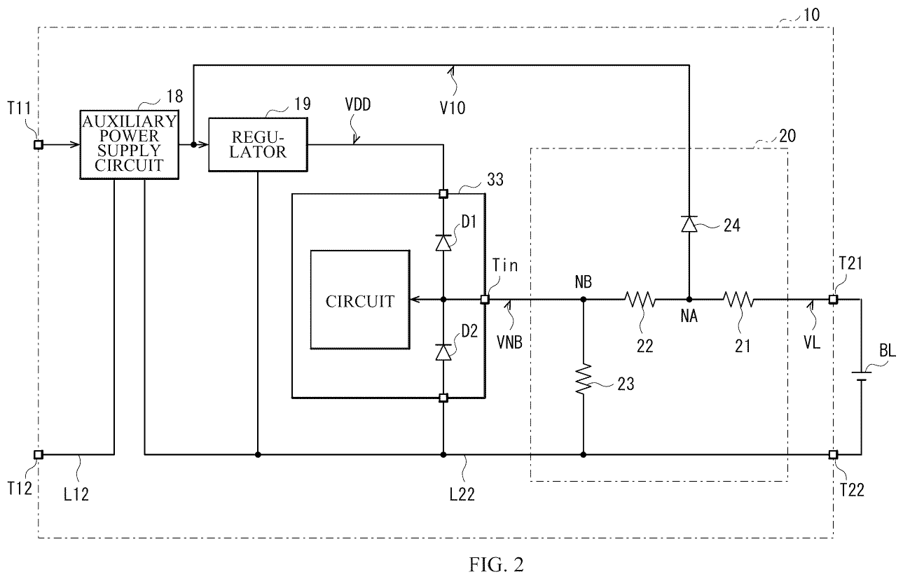

FIG. 2 illustrates a configuration example of the sensor circuit 20. For convenience of description, FIG. 2 also illustrates the auxiliary power supply circuit 18, the regulator 19, the control circuit 33, and the low voltage battery BL, in addition to the sensor circuit 20.

The sensor circuit 20 includes resistors 21 to 23 and a diode 24. The resistor 21 may have a first end coupled to the terminal T21, and a second end coupled to a node NA. The resistor 22 may have a first end coupled to the node NA, and a second end coupled to a node NB. The node NB may be coupled to an input terminal Tin of the control circuit 33. The resistor 23 may have a first end coupled to the node NB, and a second end coupled to the reference voltage line L22. The diode 24 includes an anode coupled to the node NA, and a cathode to be supplied with the power supply voltage V10.

The driving circuit 31 illustrated in FIG. 1 may be configured to generate the gate signals GA to GD, respectively based on gate signals GA1 to GD1 supplied from the control circuit 33.

The driving circuit 32 may be configured to generate the gate signals GE and GF, respectively based on gate signals GE1 and GF1 supplied from the control circuit 33.

The control circuit 33 may be configured to control operation of the electric power conversion apparatus 10 by controlling operation of each of the switching circuit 12 and the rectifying circuit 14, based on the voltage VNB supplied from the sensor circuit 20. For example, the control circuit 33 may generate the gate signals GA1 to GF1, based on the voltage VNB and perform pulse width modulation (PWM) control, based on the gate signals GA1 to GF1 to thereby control the operation of the electric power conversion apparatus 10 to cause the voltage VL to be at a predetermined value, which may be 12 V in the example embodiment. The control circuit 33 operates based on the power supply voltage VDD supplied from the regulator 19. The control circuit 33 may be an integrated circuit and may include a microcontroller, for example.

As illustrated in FIG. 2, the control circuit 33 may include diodes D1 and D2. The diodes D1 and D2 may each be what is called a protective diode and may protect the control circuit 33. The diode D1 may include an anode coupled to the input terminal Tin, and a cathode coupled to a power supply terminal of the control circuit 33. The power supply terminal may receive the power supply voltage VDD. The diode D2 may include an anode coupled to a ground terminal of the control circuit 33, and a cathode coupled to the input terminal Tin. The ground terminal may be coupled to the reference voltage line L22.

The low voltage battery BL illustrated in FIG. 1 may be configured to store electric power supplied from the electric power conversion apparatus 10. A voltage at the low voltage battery BL may be 12 V in the example embodiment.

With this configuration, the electric power conversion system 1 may perform an electric power conversion operation of converting electric power supplied from the high voltage battery BH and supplying the converted electric power to the low voltage battery BL.

Here, the terminal T11 may correspond to a specific but non-limiting example of an “electric power input terminal” in one embodiment of the disclosure. The electric power conversion circuit 100 may correspond to a specific but non-limiting example of an “electric power conversion circuit” in one embodiment of the disclosure. The terminal T21 may correspond to a specific but non-limiting example of an “electric power output terminal” in one embodiment of the disclosure. The sensor circuit 20 may correspond to a specific but non-limiting example of a “sensor circuit” in one embodiment of the disclosure. The voltage VNB may correspond to a specific but non-limiting example of a “detection voltage” in one embodiment of the disclosure. The control circuit 33 may correspond to a specific but non-limiting example of a “control circuit” in one embodiment of the disclosure. The input terminal Tin may correspond to a specific but non-limiting example of an “input terminal” in one embodiment of the disclosure. The auxiliary power supply circuit 18 and the regulator 19 may correspond to a specific but non-limiting example of a “power supply circuit” in one embodiment of the disclosure. The power supply voltage VDD may correspond to a specific but non-limiting example of a “first power supply voltage” in one embodiment of the disclosure. The power supply voltage V10 may correspond to a specific but non-limiting example of a “second power supply voltage” in one embodiment of the disclosure.

The node NA may correspond to a specific but non-limiting example of a “first intermediate node” in one embodiment of the disclosure. The node NB may correspond to a specific but non-limiting example of a “second intermediate node” in one embodiment of the disclosure. The reference voltage line L22 may correspond to a specific but non-limiting example of a “reference node” in one embodiment of the disclosure. The resistors 21 to 23 may correspond to a specific but non-limiting example of “resistors” in one embodiment of the disclosure. The resistor 21 may correspond to a specific but non-limiting example of a “first resistor” in one embodiment of the disclosure. The resistor 22 may correspond to a specific but non-limiting example of a “second resistor” in one embodiment of the disclosure. The resistor 23 may correspond to a specific but non-limiting example of a “third resistor” in one embodiment of the disclosure. The diode 24 may correspond to a specific but non-limiting example of a “first diode” in one embodiment of the disclosure.

The high voltage battery BH may correspond to a specific but non-limiting example of a “first battery” in one embodiment of the disclosure. The capacitor 9 may correspond to a specific but non-limiting example of a “capacitor” in one embodiment of the disclosure. The switch SW1 may correspond to a specific but non-limiting example of a “first switch” in one embodiment of the disclosure. The switch SW2 may correspond to a specific but non-limiting example of a “second switch” in one embodiment of the disclosure. The low voltage battery BL may correspond to a specific but non-limiting example of a “second battery” in one embodiment of the disclosure.

### <Operation and Workings>

Next, a description will be given of operation and workings of the electric power conversion system 1 of the example embodiment.

### <Outline of Overall Operation>

First, an outline of overall operation of the electric power conversion system 1 will be described with reference to FIG. 1. When the electric power conversion system 1 starts up, first, the switches SW1 and SW2 may switch from an off-state to an on-state, based on an instruction from the unillustrated system control processor. This may allow electric power to be supplied from the high voltage battery BH to the terminals T11 and T12 of the electric power conversion apparatus 10. Thereafter, the auxiliary power supply circuit 18 may generate the power supply voltage V10, based on the voltage VH, and the regulator 19 may generate the power supply voltage VDD, based on the power supply voltage V10. The control circuit 33 may start operating, based on the power supply voltage VDD. The control circuit 33 may control the operation of the electric power conversion apparatus 10 by controlling the operation of each of the switching circuit 12 and the rectifying circuit 14, based on the voltage VNB supplied from the sensor circuit 20. The electric power conversion apparatus 10 may thus convert the electric power supplied from the high voltage battery BH and supply the converted electric power to the low voltage battery BL.

### <Detailed Operation>

Next, the sensor circuit 20 will be described in detail.

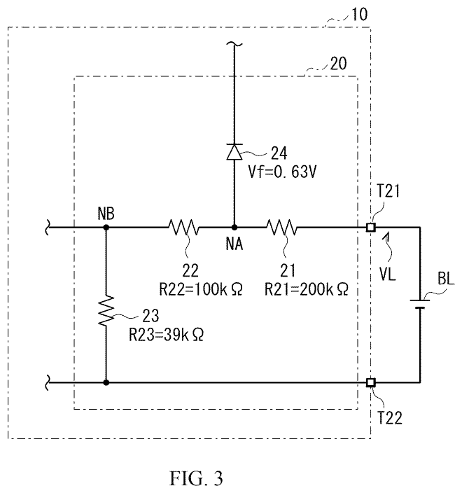

FIG. 3 illustrates an example of circuit constants of the sensor circuit 20. A resistance value R21 of the resistor 21 may be 200 k (2, a resistance value R22 of the resistor 22 may be 100 kΩ, and a resistance value R23 of the resistor 23 may be 39 kΩ. A forward voltage Vf of the diode 24 may be 0.63 V.

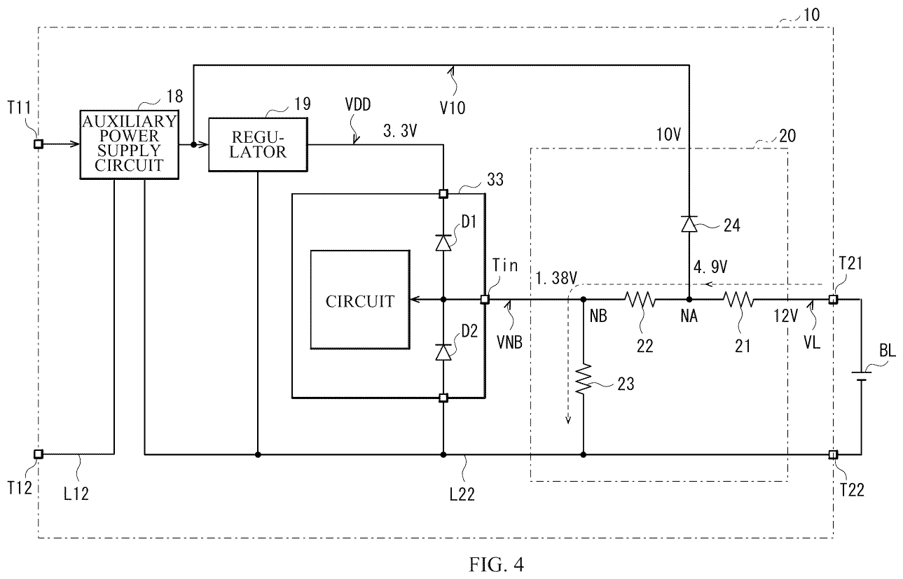

FIG. 4 illustrates an example of operation of the sensor circuit 20 when the switches SW1 and SW2 are in the on-state and the electric power conversion apparatus 10 is performing the electric power conversion operation. The switches SW1 and SW2 in the on-state may allow the terminals T11 and T12 of the electric power conversion apparatus 10 to be coupled to the high voltage battery BH. Thus, the auxiliary power supply circuit 18 may generate the power supply voltage V10, based on the voltage VH, and the regulator 19 may generate the power supply voltage VDD, based on the power supply voltage V10. The power supply voltage V10 may be 10 V, and the power supply voltage VDD may be 3.3 V.

The voltage VL at the terminal T21 may be 12 V. A voltage VNA and the voltage VNB expressed by the following expressions may develop at the node NA and the node NB, respectively.

$$VNA = VL \times ( R 22 + R 23 ) / ( R 21 + R 22 + R 23 )$$

$$VNB = VL \times ( R 23 ) / ( R 21 + R 22 + R 23 )$$

When the circuit constants illustrated in FIG. 3 are used, the voltage VNA may be 4.9 V and the voltage VNB may be 1.38 V.

In this case, a voltage at the anode of the diode 24 may be 4.9 V and a voltage at the cathode of the diode 24 may be 10 V, which may bring the diode 24 into an off-state. Accordingly, as illustrated in FIG. 4, a current may flow from the low voltage battery BL through the terminal T21, the resistor 21, the resistor 22, and the resistor 23 in this order. The current may have a current value of 35 uA. The voltage VNB at the node NB may then be received at the input terminal Tin of the control circuit 33. Based on the voltage VNB, the control circuit 33 may control the operation of each of the switching circuit 12 and the rectifying circuit 14 to cause the voltage VL to be 12 V.

Before the electric power conversion system 1 starts up, the switches SW1 and SW2 may be in the off-state. Accordingly, the terminals T11 and T12 of the electric power conversion apparatus 10 may not be coupled to the high voltage battery BH. In contrast, the terminals T21 and T22 of the electric power conversion apparatus 10 may be coupled to the low voltage battery BL.

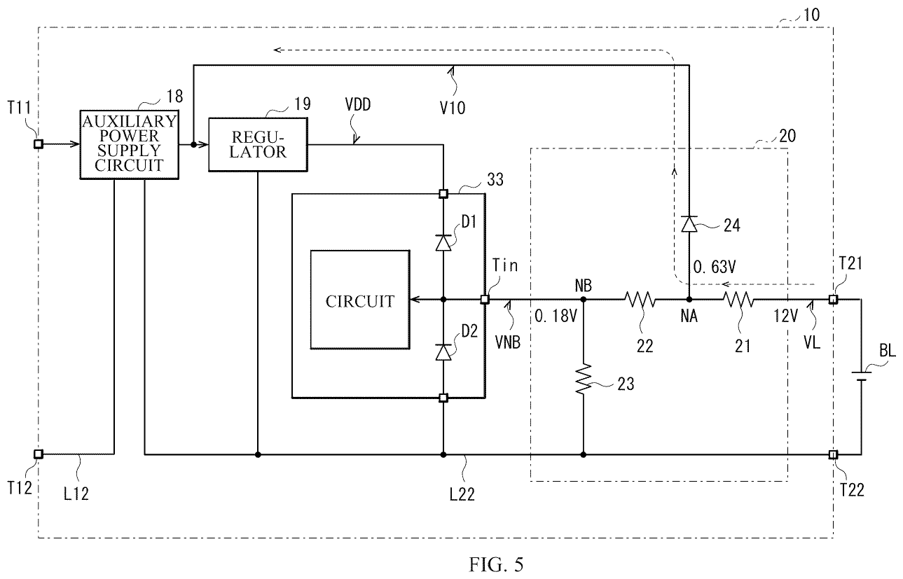

FIG. 5 illustrates an example of operation of the sensor circuit 20 when the switches SW1 and SW2 are in the off-state. The switches SW1 and SW2 in the off-state may allow no electric power to be supplied from the high voltage battery BH to the terminals T11 and T12 of the electric power conversion apparatus 10. Thus, neither the auxiliary power supply circuit 18 nor the regulator 19 may operate. As a result, the power supply voltages V10 and VDD may both be 0 V.

In this case, the diode 24 may be in an on-state because the voltage at the cathode of the diode 24 is 0 V. In this situation, most of the current from the low voltage battery BL may flow through the terminal T21, the resistor 21, and the diode 24 in this order, as illustrated in FIG. 5. The voltage VNA at the node NA may correspond to the forward voltage Vf of the diode 24 and thus be 0.63 V. As a result, the voltage VNB at the node NB may be 0.18 V. The sensor circuit 20 helps to keep down the voltage VNB to 0.3 V or less even with, for example, device-to-device variations and temperature variations taken into account.

For example, there may be cases where a rating of an input voltage in an integrated circuit is equal to a power supply voltage plus 0.3 V. Even when the power supply voltage VDD at the control circuit 33 is 0 V, the sensor circuit 20 helps to satisfy the rating of the input voltage at the control circuit 33 by helping to keep down the voltage VNB, which is to be received at the input terminal Tin, to 0.3 V or less.

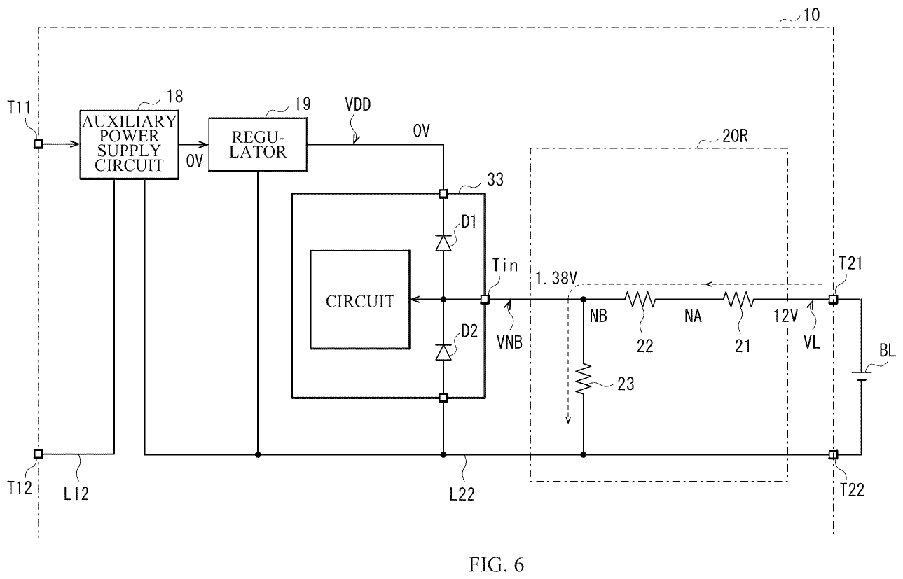

For example, assume that a sensor circuit 20R is configured without the diode 24, as illustrated in FIG. 6. In such a case, the voltage VNB would be 1.38 V. Accordingly, it is difficult to satisfy the rating of the input voltage at the control circuit 33 when the power supply voltage VDD at the control circuit 33 is 0 V. In contrast, the sensor circuit 20 according to the example embodiment includes the diode 24. This helps to satisfy the rating of the input voltage.

As described above, the electric power conversion apparatus 10 includes the electric power input terminal (the terminal T11), the electric power output terminal (the terminal T21), the electric power conversion circuit 100, the sensor circuit 20, the control circuit 33, and the power supply circuit (the auxiliary power supply circuit 18 and the regulator 19). The electric power conversion circuit 100 is configured to perform the electric power conversion operation, based on electric power received at the electric power input terminal (the terminal T11), and is configured to output electric power generated through the electric power conversion operation from the electric power output terminal (the terminal T21). The sensor circuit 20 is configured to generate, based on the voltage at the electric power output terminal (the terminal T21), the detection voltage (the voltage VNB) corresponding to the voltage at the electric power output terminal (the terminal T21). The control circuit 33 is configured to operate based on the first power supply voltage (the power supply voltage VDD). The control circuit 33 includes the input terminal Tin configured to receive the detection voltage (the voltage VNB), and is configured to control the operation of the electric power conversion circuit 100, based on the detection voltage (the voltage VNB). The power supply circuit (the auxiliary power supply circuit 18 and the regulator 19) is configured to generate, based on the electric power received at the electric power input terminal (the terminal T11), the first power supply voltage (the power supply voltage VDD) and the second power supply voltage (the power supply voltage V10), the second power supply voltage being higher than the first power supply voltage. The sensor circuit 20 includes the resistors (the resistors 21 to 23) and the first diode (the diode 24). The resistors (the resistors 21 to 23) are provided in a path coupling the electric power output terminal (the terminal T21) and the reference node (the reference voltage line L22) to each other, and are coupled in series to each other via the first intermediate node (the node NA) and the second intermediate node (the node NB). The second intermediate node is positioned closer to the reference node than the first intermediate node, and is coupled to the input terminal Tin of the control circuit 33. The first diode (the diode 24) includes the anode coupled to the first intermediate node, and the cathode configured to be supplied with the second power supply voltage (the power supply voltage V10). This helps to prevent, in the electric power conversion apparatus 10, any voltage exceeding the rating from being received at the input terminal Tin of the control circuit 33 as described above, which in turn helps to protect the circuit.

In some embodiments, in the electric power conversion apparatus 10, the first diode (the diode 24) may be configured to come into the off-state in a period during which the power supply circuit (the auxiliary power supply circuit 18 and the regulator 19) is in operation, and configured to come into the on-state in a period during which the power supply circuit (the auxiliary power supply circuit 18 and the regulator 19) is not in operation. For example, as illustrated in FIG. 4, when the switches SW1 and SW2 are in the on-state, the auxiliary power supply circuit 18 may generate the power supply voltage V10, based on the voltage VH, and the regulator 19 may generate the power supply voltage VDD, based on the power supply voltage V10. Thus, when the auxiliary power supply circuit 18 and the regulator 19 are in operation, the diode 24 may be in the off-state. Further, for example, as illustrated in FIG. 5, when the switches SW1 and SW2 are in the off-state, the auxiliary power supply circuit 18 and the regulator 19 may not be in operation. In this case, the diode 24 may come into the on-state. This helps to prevent, in the electric power conversion apparatus 10, any voltage exceeding the rating from being received at the input terminal Tin of the control circuit 33 as described above, which in turn helps to protect the circuit.

### Example Effects

As described above, an electric power conversion apparatus and an electric power conversion system according to at least one embodiment of the disclosure each include an electric power input terminal, an electric power output terminal, an electric power conversion circuit, a sensor circuit, a control circuit, and a power supply circuit. The electric power conversion circuit is configured to perform an electric power conversion operation, based on electric power received at the electric power input terminal, and is configured to output electric power generated through the electric power conversion operation from the electric power output terminal. The sensor circuit is configured to generate, based on a voltage at the electric power output terminal, a detection voltage corresponding to the voltage at the electric power output terminal. The control circuit is configured to operate based on a first power supply voltage. The control circuit includes an input terminal configured to receive the detection voltage, and is configured to control operation of the electric power conversion circuit, based on the detection voltage. The power supply circuit is configured to generate, based on the electric power received at the electric power input terminal, the first power supply voltage and a second power supply voltage, the second power supply voltage being higher than the first power supply voltage. The sensor circuit includes resistors and a first diode. The resistors are provided in a path coupling the electric power output terminal and a reference node to each other, and are coupled in series to each other via a first intermediate node and a second intermediate node. The second intermediate node is positioned closer to the reference node than the first intermediate node, and is coupled to the input terminal of the control circuit. The first diode includes an anode coupled to the first intermediate node, and a cathode configured to be supplied with the second power supply voltage. This helps to protect a circuit.

In some embodiments, the first diode may be configured to come into an off-state in a period during which the power supply circuit is in operation, and configured to come into an on-state in a period during which the power supply circuit is not in operation. This helps to protect a circuit.

### Modification Example 1

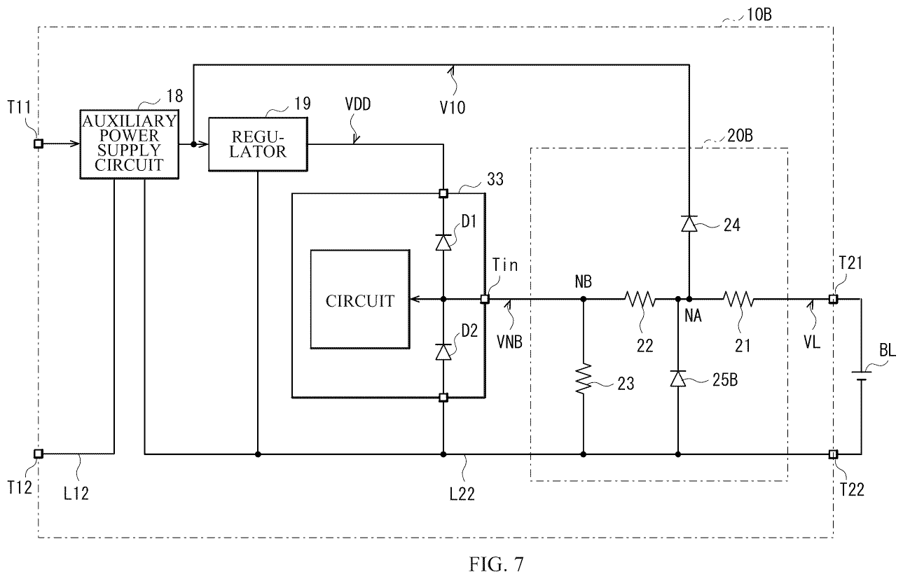

In the foregoing example embodiment, the sensor circuit 20 includes the resistors 21 to 23 and the diode 24; however, this is non-limiting. In some embodiments, a second diode may be provided, as in an electric power conversion apparatus 10B illustrated in FIG. 7, for example. The electric power conversion apparatus 10B includes a sensor circuit 20B. The sensor circuit 20B may include a diode 25B. The diode 25B may include an anode coupled to the reference voltage line L22, and a cathode coupled to the node NA. This helps to reduce an influence that a reverse current of the diode 24 can exert on accuracy of detection of the voltage VL, for example. For example, referring to FIG. 4, when the electric power conversion apparatus 10 performs the electric power conversion operation, the reverse current flowing from the cathode of the diode 24 toward the anode of the diode 24 can exert an influence on the voltage VNB at the node NB. In the sensor circuit 20B, the provision of the diode 25B allows a reverse current to flow from the cathode of the diode 25B toward the anode of the diode 25B. This helps to reduce the influence that the reverse current of the diode 24 can exert on the voltage VNB.

### Modification Example 2

In the foregoing example embodiment, the switches SW1 and SW2 may be provided and the electric power conversion apparatus 10 may perform the electric power conversion operation after the switches SW1 and SW2 are turned on. In some embodiments, in a period before the switches SW1 and SW2 are turned on, for example, what is called a precharge operation may be performed, that is, an operation of charging the capacitor 9 by supplying electric power from the low voltage battery BL to the primary-side circuitry via the transformer 13 may be performed. This helps to allow the electric power conversion apparatus 10 to reduce an inrush current that flows from the high voltage battery BH to the capacitor 9 upon turning-on of the switches SW1 and SW2.

### Modification Example 3

In the foregoing example embodiment, the electric power conversion apparatus 10 may have the circuit configuration illustrated in FIG. 1; however, this is non-limiting. In some embodiments, the switching circuit 12 in the primary-side circuitry may be a half-bridge circuit. In some embodiments, the rectifying circuit 14 in the secondary-side circuitry may include a diode. Further, although the electric power conversion apparatus 10 may be an isolated circuit including the transformer 13, this is non-limiting. In some embodiments, the electric power conversion apparatus 10 may be a non-isolated circuit.

### Other Modification Examples

Any two or more of the foregoing modification examples may be employed in combination. Further, the disclosure encompasses any possible combination of some or all of the various embodiments described herein and incorporated herein.

The disclosure has been described hereinabove with reference to the example embodiment and the modification examples. However, the disclosure is not limited thereto, and various modifications may be made.

For example, the circuit constants illustrated in FIG. 3 are merely exemplary, and may be changed as appropriate.

The effects described herein are mere examples, and effects of an embodiment of the disclosure are not limited thereto. Accordingly, any other effect may be obtained in relation to the embodiment of the disclosure.

An embodiment of the disclosure may have any of the following configurations.

(1)

An electric power conversion apparatus including:
an electric power input terminal;
an electric power output terminal;
an electric power conversion circuit configured to perform an electric power conversion operation, based on electric power received at the electric power input terminal, and configured to output electric power generated through the electric power conversion operation from the electric power output terminal;
a sensor circuit configured to generate, based on a voltage at the electric power output terminal, a detection voltage corresponding to the voltage at the electric power output terminal;
a control circuit configured to operate based on a first power supply voltage, the control circuit including an input terminal configured to receive the detection voltage and being configured to control operation of the electric power conversion circuit, based on the detection voltage; and
a power supply circuit configured to generate, based on the electric power received at the electric power input terminal, the first power supply voltage and a second power supply voltage, the second power supply voltage being higher than the first power supply voltage, in which
the sensor circuit includes
   resistors that are provided in a path coupling the electric power output terminal and a reference node to each other, and that are coupled in series to each other via a first intermediate node and a second intermediate node, the second intermediate node being positioned closer to the reference node than the first intermediate node and being coupled to the input terminal of the control circuit, and
   a first diode including an anode coupled to the first intermediate node, and a cathode configured to be supplied with the second power supply voltage.
      (2)

The electric power conversion apparatus according to (1), in which the first diode is configured to come into an off-state in a period during which the power supply circuit is in operation, and configured to come into an on-state in a period during which the power supply circuit is not in operation.

(3)

The electric power conversion apparatus according to (1) or (2), in which the sensor circuit further includes a second diode, the second diode including an anode coupled to the reference node, and a cathode coupled to the first intermediate node.

(4)

The electric power conversion apparatus according to any one of (1) to (3), in which the resistors include:
a first resistor having a first end coupled to the electric power output terminal, and a second end coupled to the first intermediate node;
a second resistor having a first end coupled to the first intermediate node, and a second end coupled to the second intermediate node; and
a third resistor having a first end coupled to the second intermediate node, and a second end coupled to the reference node.
   (5)

An electric power conversion system including:
a first battery including a first terminal and a second terminal;
a capacitor including a first terminal and a second terminal;
a first switch provided in a path coupling the first terminal of the first battery and the first terminal of the capacitor to each other;
a second switch provided in a path coupling the second terminal of the first battery and the second terminal of the capacitor to each other;
an electric power conversion apparatus; and
a second battery,
the electric power conversion apparatus including
   an electric power input terminal coupled to the capacitor,
   an electric power output terminal coupled to the second battery,
   an electric power conversion circuit configured to perform an electric power conversion operation, based on electric power received at the electric power input terminal, and configured to output electric power generated through the electric power conversion operation from the electric power output terminal,
   a sensor circuit configured to generate, based on a voltage at the electric power output terminal, a detection voltage corresponding to the voltage at the electric power output terminal,
   a control circuit configured to operate based on a first power supply voltage, the control circuit including an input terminal configured to receive the detection voltage and being configured to control operation of the electric power conversion circuit, based on the detection voltage, and
   a power supply circuit configured to generate, based on the electric power received at the electric power input terminal, the first power supply voltage and a second power supply voltage, the second power supply voltage being higher than the first power supply voltage, in which
the sensor circuit includes
   resistors that are provided in a path coupling the electric power output terminal and a reference node to each other, and that are coupled in series to each other via a first intermediate node and a second intermediate node, the second intermediate node being positioned closer to the reference node than the first intermediate node and being coupled to the input terminal of the control circuit, and
   a first diode including an anode coupled to the first intermediate node, and a cathode configured to be supplied with the second power supply voltage.

An electric power conversion apparatus and an electric power conversion system according to at least one embodiment of the disclosure each make it possible to protect a circuit.

Although the disclosure has been described hereinabove in terms of the example embodiment and modification examples, the disclosure is not limited thereto. It should be appreciated that variations may be made in the described example embodiment and modification examples by those skilled in the art without departing from the scope of the disclosure as defined by the following claims. The limitations in the claims are to be interpreted broadly based on the language employed in the claims and not limited to examples described in this specification or during the prosecution of the application, and the examples are to be construed as non-exclusive. The use of the terms first, second, etc. do not denote any order or importance, but rather the terms first, second, etc. are used to distinguish one element from another. The term “substantially” and its variants are defined as being largely but not necessarily wholly what is specified as understood by one of ordinary skill in the art. The term “disposed on/provided on/formed on” and its variants as used herein refer to elements disposed directly in contact with each other or indirectly by having intervening structures therebetween. Moreover, no element or component in this disclosure is intended to be dedicated to the public regardless of whether the element or component is explicitly recited in the following claims.

What is claimed is:

1. An electric power conversion apparatus comprising:
an electric power input terminal;
an electric power output terminal;
an electric power conversion circuit configured to perform an electric power conversion operation, based on electric power received at the electric power input terminal, and configured to output electric power generated through the electric power conversion operation from the electric power output terminal;
a sensor circuit configured to generate, based on a voltage at the electric power output terminal, a detection voltage corresponding to the voltage at the electric power output terminal;
a control circuit configured to operate based on a first power supply voltage, the control circuit including an input terminal configured to receive the detection voltage and being configured to control operation of the electric power conversion circuit, based on the detection voltage; and
a power supply circuit configured to generate, based on the electric power received at the electric power input terminal, the first power supply voltage and a second power supply voltage, the second power supply voltage being higher than the first power supply voltage, wherein
the sensor circuit includes
resistors that are provided in a path coupling the electric power output terminal and a reference node to each other, and that are coupled in series to each other via a first intermediate node and a second intermediate node, the second intermediate node being positioned closer to the reference node than the first intermediate node and being coupled to the input terminal of the control circuit, and
a first diode including an anode coupled to the first intermediate node, and a cathode configured to be supplied with the second power supply voltage.

2. The electric power conversion apparatus according to claim 1, wherein the first diode is configured to come into an off-state in a period during which the power supply circuit is in operation, and configured to come into an on-state in a period during which the power supply circuit is not in operation.

3. The electric power conversion apparatus according to claim 1, wherein the sensor circuit further includes a second diode, the second diode including an anode coupled to the reference node, and a cathode coupled to the first intermediate node.

4. The electric power conversion apparatus according to claim 1, wherein the resistors include:
a first resistor having a first end coupled to the electric power output terminal, and a second end coupled to the first intermediate node;
a second resistor having a first end coupled to the first intermediate node, and a second end coupled to the second intermediate node; and
a third resistor having a first end coupled to the second intermediate node, and a second end coupled to the reference node.

5. An electric power conversion system comprising:
a first battery including a first terminal and a second terminal;
a capacitor including a first terminal and a second terminal;
a first switch provided in a path coupling the first terminal of the first battery and the first terminal of the capacitor to each other;
a second switch provided in a path coupling the second terminal of the first battery and the second terminal of the capacitor to each other;
an electric power conversion apparatus; and
a second battery,
the electric power conversion apparatus including
an electric power input terminal coupled to the capacitor,
an electric power output terminal coupled to the second battery,
an electric power conversion circuit configured to perform an electric power conversion operation, based on electric power received at the electric power input terminal, and configured to output electric power generated through the electric power conversion operation from the electric power output terminal,
a sensor circuit configured to generate, based on a voltage at the electric power output terminal, a detection voltage corresponding to the voltage at the electric power output terminal,
a control circuit configured to operate based on a first power supply voltage, the control circuit including an input terminal configured to receive the detection voltage and being configured to control operation of the electric power conversion circuit, based on the detection voltage, and
a power supply circuit configured to generate, based on the electric power received at the electric power input terminal, the first power supply voltage and a second power supply voltage, the second power supply voltage being higher than the first power supply voltage, wherein
the sensor circuit includes
resistors that are provided in a path coupling the electric power output terminal and a reference node to each other, and that are coupled in series to each other via a first intermediate node and a second intermediate node, the second intermediate node being positioned closer to the reference node than the first intermediate node and being coupled to the input terminal of the control circuit, and
a first diode including an anode coupled to the first intermediate node, and a cathode configured to be supplied with the second power supply voltage.
